(19) United States
(12) Patent Application Publication
(10) Pub. No.: US 2008/0293457 A1
(43) Pub. Date: Nov. 27, 2008

(54) Mobile phone

(75) Inventors: Ching-Sung Chang, Taipei (TW); Sea-Weng Young, Taipei (TW)

Correspondence Address: BIRCH STEWART KOLASCH & BIRCH, PO BOX 747, FALLS CHURCH, VA, 22040-0747, US

(73) Assignee: Inventec Appliances Corp., Taipei (TW)

(21) Appl. No.: 12/081,827

(22) Filed: Apr. 22, 2008

(30) Foreign Application Priority Data
May 21, 2007 (TW) 96118011

(51) Int. Cl. H04M 1/00

(52) U.S. Cl. 455/575.1; 345/169

(57) ABSTRACT

A mobile phone includes a housing and a keypad module. The keypad module is mounted detachably on the housing. The keypad module is double-sided and has a first user interface and a second user interface formed on two corresponding sides for providing operations different from each other.

### FIELD OF THE INVENTION

The invention relates to a mobile phone, more particularly to a mobile phone having several user interfaces simultaneously.

### BACKGROUND OF THE INVENTION

Since a mobile phone has multi-functions and compact size and is light-weighted, it has become an indispensable communication device in our daily life. As the manufacturer concerned expand ceaselessly its functions, everybody has at least one mobile phone, which serves as a portable computer. All these additional functions workable previously only on the on-line computer are added into the majority of the mobile phones for the users to access the additional functions.

The more the additional functions increases, the more concentration of every manufacturer is directed to the available limited space as to make the outmost efficiency to accommodate the operating keys corresponding to the additional functions. For instance, a traditional compact keyboard can be coupled to a PDA (Personal Digital Assistant) in order to facilitate the user to compile or edit a text document. The key on such compact keyboard is too small in dimension and may lead the user to inconvenience during pressing of the keys, hence preventing fast data input. Most PDAs are equipped with input devices consisting of a display panel and a stylus for tapping input data and writing words or characters, thereby quickening the data input. Of course, equipping the PDAs with the additional tools will result in extra manufacturing cost; the purchase price for the PDAs will go higher so is the volume or size of the PDAs.

Another type of mobile phone is available in the market, wherein the mobile phone is equipped with an externally connected keyboard such that when the user requires additional keys for the added functions, the object can be achieved by attachment of the keyboard to the PDA. Cable-connected devices (like USB) or wireless connection devices (like Bluetooth-enabled devices) can be implemented for coupling the keyboard to the PDA. The attachment of keyboard to the PDA in order to obtain the expanded keys though does not result in high cost, but decreases the portability of the mobile phone when considered from the user's views.

Therefore, under the consideration to provide multi-functions for the mobile phone and simultaneously minimizing its volume, it is an important factor for the manufacturers concerned to provide an easy data input mode of the mobile phone.

### SUMMARY OF THE INVENTION

The object of the present invention is to provide a mobile phone, which has several user interfaces simultaneously so as to permit several input modes by the user.

A mobile phone is provided according to the present invention and includes a housing and a keypad module. The keypad module is mounted detachably on the housing. The keypad module is double-sided and has a first user interface and a second user interface formed on two corresponding sides for providing operations different from each other.

As mentioned above, the mobile phone of the present invention includes a double-sided keypad module with different user interfaces and is mounted detachably on a housing in such a manner that the total volume or area of the housing is not increased due to attachment of the keypad module. The keypad module of the present invention occupies a relatively small room when compared to the prior art technology, where a cable-connected or wireless keypad module is utilized. Therefore, the portability of the present mobile phone is enhanced.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a perspective view of one embodiment of the mobile phone of the present invention;

FIG. 2 is a block diagram illustrating a keypad module employed in the mobile phone of the present invention;

FIGS. 3A and 3B respectively show two sides of the keypad module shown in FIG. 2; and

FIGS. 4A and 4B respectively show perspective views of another embodiment of the mobile phone of the present invention.

### DETAILED DESCRIPTIONS OF THE PREFERRED EMBODIMENTS

As mentioned in the prior technology, there always remain a problem under the consideration to provide multi-functions and compact size for the mobile phone. The mobile phone disclosed in accordance with the present invention is provided with a detachable keypad module, wherein two different user interfaces are provided at two corresponding sides thereof so as to facilitate the input modes of the mobile phone.

The following discloses one embodiment of the present invention. The structure thereof should not be limited only the disclosed embodiment, several modifications may be encompassed within the spirit of the present invention.

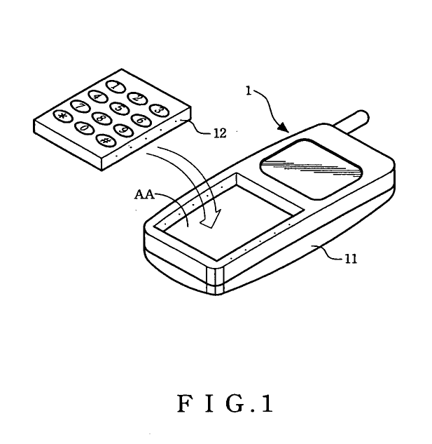

FIG. 1 illustrates a perspective view of one embodiment of the mobile phone 1 of the present invention. The mobile phone 1 includes a housing 11 and a keypad module 12. The housing 11 is formed with a reception recess AA. The keypad module 12 is mounted detachably in the reception recess AA and is further coupled electrically to the housing 11. The keypad module 12 is double-sided and has a first user interface and a second user interface formed on two corresponding sides for providing operations different from each other.

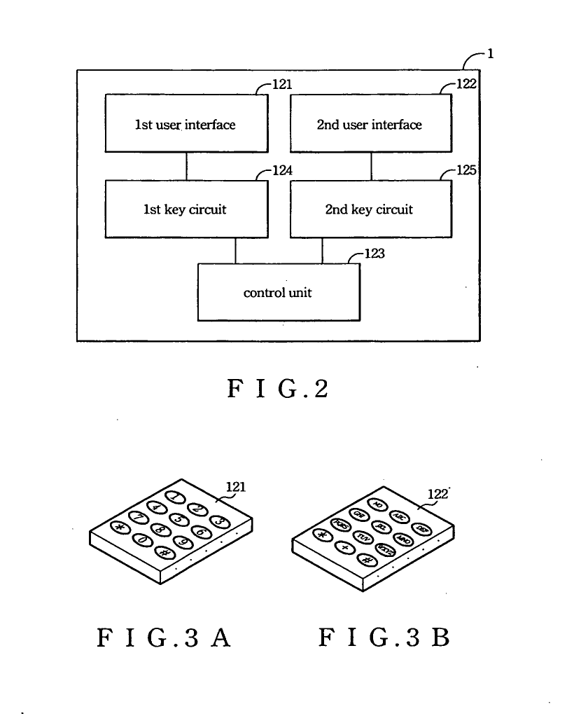

FIG. 2 is a block diagram illustrating the keypad module 12 employed in the mobile phone 1 of the present invention. The keypad module 12 includes the first user interface 121, the second user interface 122, a control unit 123, a first key circuit 124 and a second key circuit 125. The first user interface 121 has a plurality of operating keys. The activation of one of the operating keys of the first user interface 121 causes the first key circuit 124 to generate a corresponding signal and sending the corresponding signal to the control unit 123 in order to perform the corresponding task. In the same manner, the second user interface 122 has a plurality of operating keys. The activation of one of the operating keys of the second user interface 122 causes the second key circuit 125 to generate a corresponding signal and sending the corresponding signal to the control unit 123 in order to perform the corresponding task. Regarding mounting of the keypad module 12 within the reception recess AA is not limited to only the disclosed embodiment, so long as the coupling pins on the keypad module are electrically connected to the circuit board of the housing, such as by snap-fitting, plug-in securing means can be employed. Persons skilled in the art can easily understand that several other variations can be implemented; a detailed discussion thereof is herein omitted for the same of brevity.

FIGS. 3A and 3B respectively show two sides of the keypad module 12. In this embodiment, the first and second user interfaces 121, 122 are mounted on two opposite sides of the keypad module 12. The first user interface 121 has a plurality of keys; each is imprinted with a number so that the user can press (i.e. by pressing means) the keys to input the corresponding numbers. The second user interface 122 has a plurality of keys; each is imprinted with a character or letter so that the user can press the keys to input the corresponding characters or letters in a text format.

The keypad module 12 is double-sided and since the keys are formed on two sides, a pressing area available on each of the keys is larger when compared to that available on the corresponding key of the light-weight and compact mobile phone of the prior art. Under this condition, input ability of the user is increased with ease.

The aforementioned first and second user interfaces are used to illustrate the flexible usage of the keypad module, and therefore should not be limited only to the disclosed embodiment. Mobile phones of different types may require different input modes. For instance, a standard Qwerty keyboard is needed for some users so as to enable them to compile text message (or e-mail). At such condition, the keypad module of the present invention should be equipped with the Qwerty keyboard, thereby providing flexible usage to the users.

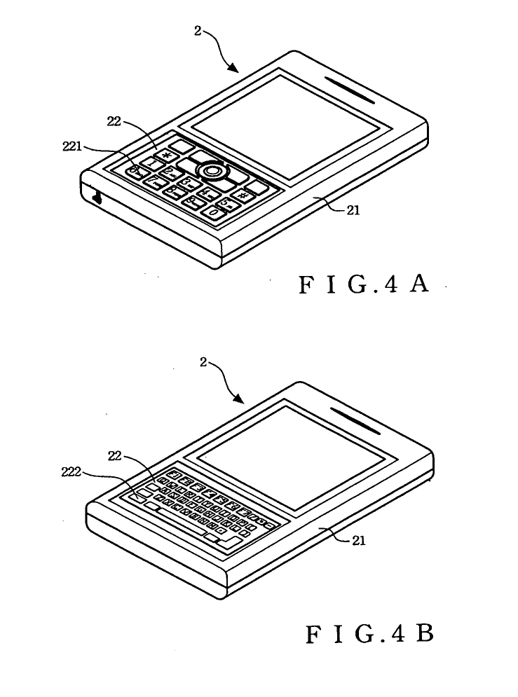

FIGS. 4A and 4B respectively show perspective views of another embodiment of the mobile phone 2 of the present invention. The mobile phone 2 accordingly includes a housing 21 and a keypad module 22. Unlike the previous embodiment, the first user interface 221 is used for dialing while the second user interface 222 is a standard Qwerty keyboard, which o enables the users to perform complicated input requirement. In one example, the housing 21 further includes a wireless transmission module (not shown), and the keypad module further includes a wireless transmission module (not shown), for transmitting and receiving wireless signals to/from the keypad module 22 and the housing 21. The wireless transmission module can be a Bluetooth module, and IR (infrared) module. For instance, when the mobile phone 2 serves as a storage disk for a projection apparatus, the keypad module 22 may serve as the remote control to operate the display operation.

As disclosed above, several user interfaces can be implemented into a double-sided keypad module detachable from a housing of the present mobile phone without increasing the volume or area thereof. The volume of the keypad module employed in the mobile phone of the present invention is obviously minimized when compared to the wireless or cable-connected standard keyboard of the prior art, thereby enhancing the user to carry the same along with him.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mobile phone comprising:
a housing; and
a keypad module mounted detachably on the housing, said keypad module being double-sided and having a first user interface and a second user interface formed on two corresponding sides for providing operations different from each other.

2. The mobile phone according to claim 1, wherein the first user interface is capable of inputting numerals.

3. The mobile phone according to claim 1, wherein the second user interface is capable of inputting letters and characters.

4. The mobile phone according to claim 1, wherein said housing further comprises a wireless transmission module for transmitting wireless signals to and receive from said keypad module.

5. The mobile phone according to claim 1, wherein said keypad module further comprises a wireless transmission module for transmitting wireless signals to and receive from said housing.
